(19) United States
(12) Patent Application Publication
(10) Pub. No.: US 2026/0177519 A1
(43) Pub. Date: Jun. 25, 2026

(54) CELLULAR AND SUB-CELLULAR BIOELECTRONIC INTERFACE(S) TO LIVING SYSTEMS AND METHODS

(71) Applicant: The Trustees of Columbia University in the City of New York, New York, NY (US)

(72) Inventor: Kenneth Shepard, Ossining, NY (US)

(21) Appl. No.: 19/429,282

(22) Filed: Dec. 22, 2025

Related U.S. Application Data
(60) Provisional application No. 63/738,586, filed on Dec. 24, 2024.

(51) Int. Cl. G01N 27/327

(52) U.S. Cl. CPC G01N 27/3271; G01N 2333/90

(57) ABSTRACT

Cellular and sub-cellular bioelectronic interface(s) to living system(s) and methods therefor including complementary metal-oxide semiconductor (CMOS) nanozyme(s), having a scale of about 9 fL to about 1 pL volume, that act to sense and/or actuate one or more molecular reactions.

### CROSS-REFERENCE TO RELATED APPLICATIONS

This application claims benefit of and priority to U.S. Provisional Application No. 63/738,586, filed Dec. 24, 2024, entitled CELLULAR AND SUB-CELLULAR BIOELECTRONIC INTERFACES TO LIVING SYSTEMS AND METHODS, the contents of which are hereby incorporated by reference.

Throughout this application various publications are referred to. Full citations for these references may be found at the end of the specification. The disclosures of these publications, and of all patents, patent application publications and books referred to herein, are hereby incorporated by reference in their entirety into the subject application to more fully describe the art to which the subject invention pertains.

### BACKGROUND INFORMATION

Complementary metal-oxide-semiconductor (CMOS) technology has been one of the drivers of the computing, communications, and artificial intelligence revolutions, creating the opportunity to scale transistors to the few-nanometer scale and facilitating centimeter-scale chips to contain tens of billions of transistors. The creation of CMOS nanoelectronics is one of the most important achievements to-date. At the same time, there has been a significant rise of scientific discoveries in the spaces of life sciences, resulting in an increased understanding of the mechanisms behind life. Thus, complex systems that have been “engineered” by billions of years of evolution. For example, proteins are the driving force of this “evolutionary engineering” performing all the key functions of living system, including structural support, enzymatic activity, transport and storage, signaling, regulatory function, motility, and energetics.

Despite considerable progress in directed-evolution techniques and machine-learning-guided design [see, e.g., Ref. 8], proteins can still be difficult to design and/or engineer. Due to this reason, there has been a growing interest in employing abiotic materials to replace some of the catalytic functionality of proteins. Nanoenzymes (or “nanozymes”) are nanomaterials [see, e.g., Refs. 9-19] that act as catalysts similar to their protein counterparts, but offer significant advantage over natural enzymes, including design flexibility, tunable physicochemical properties, high stability in harsh conditions, responsiveness to external stimuli, and low-cost production [see, e.g., Refs. 12-15]. These nanozymes, pursued for therapeutic and sensing applications [see, e.g., Refs. 12-19 and 21-25], can include various carbon- , metal- , metal oxide- , and metal-organic nanomaterials [see, e.g., Refs. 12-19 and 21-30]. The catalytic properties are derived not only from the material choice, but also from the shape and structure of the nanomaterials, which is evident in, e.g., the use of carbon-based nanostructures, such as carbon nanotubes and graphene. Nanozymes can be functionalized with targeting ligands, such as antibodies, peptides, or aptamers, to actively target specific cells or tissues. Moreover, nanozymes can be controlled with external stimuli, including magnetic fields, pH [see, e.g., Refs. 33 and 34], temperature [see, e.g., Ref. 35], light [see, e.g., Refs. 36-43], ultrasound [see, e.g., Ref. 44], heat [see, e.g., Refs. 45 and 46], and the presence of ions or small molecules. Despite these capabilities, these nanozymes are still only passive materials.

### SUMMARY OF EXEMPLARY EMBODIMENTS

It is beneficial to provide cellular and/or sub-cellular bioelectronic interface(s) to living system(s) and methods therefor, including, e.g., complementary metal-oxide semiconductor (CMOS) nanozyme(s), which can overcome at least some of the deficiencies described herein above.

The following is intended to be a brief summary of the exemplary embodiments of the present disclosure, and is not intended to limit the scope of the exemplary embodiments of the present disclosure.

According to certain exemplary embodiments of the present disclosure, exemplary semiconductor systems can be provided as, e.g., one or more CMOS integrated circuits that can take over some of the roles of proteins and/or work together with proteins, thereby providing further function(s) and/or capabilities in interfacing to a living system. Thus, it is possible to reduce the size of integrated circuits to the cellular or subcellular scale, and provide a way to power and interface them with biological systems. In various exemplary embodiments of the present disclosure, bioelectronics on the micron-scale can provide capabilities which generally currently cannot be obtained with the macro-scale interfaces. The exemplary embodiments of the present disclosure can be provided for protein engineering and nanomaterials. The exemplary systems and methods described herein can provide a number of capabilities that significantly exceed those previously available.

To that end, exemplary cellular and sub-cellular bioelectronic interface(s) to living system(s) and methods therefor according to the exemplary embodiments of the present disclosure can be provided, including, e.g., complementary metal-oxide semiconductor (CMOS) nanozyme(s). Indeed, it is possible to provide an implantable active bioelectronics device and method for use or manufacturing thereof. For example, the device can have a scale of about 1 fL volume or less that acts to sense and actuate one or more molecular reactions.

In further exemplary embodiments of the present disclosure, the actuation of the molecular reaction(s) includes catalyzing the molecular reaction(s). In embodiments, the device can be fabricated as a CMOS integrated circuit chip, and/or can be powered optically or electrochemically. The device can be configured to be communicated with using amplitude-shift-keying of an optical signal. The powering of the device electrochemically can be performed using an enzymatic fuel cell for glucose.

According to yet another exemplary embodiment of the present disclosure, the device can include an enzymatic glucose fuel cell and/or a fluorescence-based modulator configured to provide a backscatter communication. The device can sense data to drive a closed-loop response with the actuation of the molecular reaction(s). The device can also comprise a programmable processing engine integrated onto the device. The molecular reaction(s) can be sensed using ion-sensitive field-effect transistors. The molecular reaction(s) can be electrochemically sensed using potentiostats. The potentiostats can be used to drive chemical reactions.

A CMOS nanozyme device comprising:
a working electrode;
a counter electrode spaced from the working electrode;
a pH sensor configured to provide an indication of pH around the device;
the pH sensor including an ion-sensitive field effect transistor; and
a power source operable to provide electricity to the working electrode, counter electrode and pH sensor to sense or to actuate one or more chemical reactions,
optionally wherein the CMOS nanozyme device has a volume of about 1 fL or less.

In some embodiments, the working electrode and the counter electrode operate to oxidize or reduce analytes at the working electrode.

In some embodiments, the working electrode is functionalized by one or more aptamers or peptides or antibodies or antibody fragments.

In some embodiments, pH modulation is provided based on a water splitting reaction at the working electrode and the counter electrode to provide hydrogen and oxygen ions.

In some embodiments, the CMOS nanozyme device further comprises a passivation layer, wherein the passivation layer provides an ion sensitive layer of an ion-sensitive field effect transistor that associates and dissociates protons as a function of pH to modulate a gate voltage of the field effect transistor with respect to a reference field effect transistor.

In some embodiments, the gate voltage may be used to control pH modulation.

In some embodiments, the power source is optical-based.

In some embodiments, the CMOS nanozyme device further comprises a photodiode.

In some embodiments, the device receives information via amplitude-shift-keying of an optical signal.

In some embodiments, the received information may include control information to control activation of the working electrode, counter electrode and pH sensor.

In some embodiments, the CMOS nanozyme device further comprises a controller programmable using the control information to control activation of the working electrode, counter electrode and pH sensor.

In some embodiments, the CMOS nanozyme device further comprises an electro-optic fluorescence modulator provided on a surface of the device to transmit information to a fluorescence microscope.

In some embodiments, the power source is electrochemical.

In some embodiments, the CMOS nanozyme device further comprises a layer of polydimethylsiloxane provided on at least one side of the device to provide an oxygen-permeable membrane.

In some embodiments, the power source is a glucose fuel cell comprising:
a porous platinum anode formed on a bottom surface of the device;
a CeO₂ electrolyte provided above the porous platinum anode; and
a dense platinum cathode provided above the CeO₂ electrolyte,
wherein the dense platinum cathode is provided in contact with the bottom surface of the device;
wherein glucose reacts with water at the anode to provide gluconic acid and protons and electrons that pass through the electrolyte to the cathode such that the moving electrons provide electricity.

In some embodiments, the device is controlled using a closed-loop response based on actuation of molecular reactions and sensed information.

In some embodiments, the working electrode and the counter electrode provide a two-electrode potentiostat used to sense molecular reactions.

In some embodiments, the working electrode and the counter electrode provide a two-electrode potentiostat to drive chemical reactions.

In some embodiments, the device has a volume of 1 pL or less.

In some embodiments, the device is implemented as CMOS integrated circuit chip.

In some embodiments, one or more of the working electrode and counter electrode and the ion-sensitive field effect transistor include one or more molecules with desired binding properties on their surface to provide one or more targeted chemical reactions.

In some embodiments, one or more of the working electrode, counter electrodes and the ion-sensitive field effect transistor include enzymes integrated into a surface thereof.

A method for providing an implantable active bioelectronics device, comprising:
forming a CMOS nanozyme device described herein.

An implantable active bioelectronics device, comprising:
a configuration which has a scale of about 1 pL volume or less that acts to sense and actuate one or more molecular reactions.

In some embodiments, the actuation of the one or more molecular reactions includes catalyzing the one or more molecular reactions.

In some embodiments, the device is fabricated as a CMOS integrated circuit chip.

In some embodiments, the device is powered optically.

In some embodiments, the device is configured to be communicated with using amplitude-shift-keying of an optical signal.

In some embodiments, the device is powered electrochemically.

In some embodiments, the powering of the device electrochemically is performed using an enzymatic fuel cell for glucose.

In some embodiments, the device further comprises an enzymatic glucose fuel cell.

In some embodiments, the device comprises a fluorescence-based modulator configured to provide a backscatter communication.

In some embodiments, the device senses data to drive a closed-loop response with the actuation of the one or more molecular reactions.

In some embodiments, the device further comprises a programmable processing engine integrated onto the device.

In some embodiments, the one or more molecular reactions are sensed using ion-sensitive field-effect transistors.

In some embodiments, the one or more molecular reactions are electrochemically sensed potentiostats.

In some embodiments, the device further comprise potentiostats configured to drive chemical reactions.

A CMOS nanozyme device comprising:
a working electrode;
a counter electrode spaced from the working electrode;
an ion-sensitive field effect transistor; and
a power source operable to provide electricity to the working electrode, counter electrode and ion-sensitive field effect transistor.

A CMOS nanozyme device comprising:
a working electrode;
a counter electrode spaced from the working electrode;
an ion-sensitive field effect transistor as a sensor for pH, NH3, CO2, O2, NO, or urea around the device; and
a power source operable to provide electricity to the working electrode, counter electrode and ion-sensitive field effect transistor to sense pH, NH3, CO2, O2, NO, or urea or one or more chemical reactions.

A CMOS nanozyme device comprising:
a working electrode;
a counter electrode spaced from the working electrode;
a temperature sensor to sense temperature around the device; and
a power source operable to provide electricity to the working electrode, counter electrode and temperature sensor.

In some embodiments, the CMOS nanozyme device is fabricated as or configured as a CMOS integrated circuit chip.

An actuating CMOS nanozyme device comprising:
a potentiostat comprising a working electrode and a pseudo-reference electrode which effects oxidation or reduction of a predefined analyte at the working electrode.

A method for providing an implantable active bioelectronics device, comprising: forming a configuration of the device which has a scale of about 1 pL volume or less that acts to sense and actuate one or more molecular reactions.

A method for effecting a molecular reaction in a cell or in an extracellular space comprising roviding a CMOS nanozyme device described herein inside the cell or extracellular space under conditions effecting powering of the CMOS nanozyme or device and thereby effecting the molecular reaction in the cell or in the extracellular space.

These and other objects, features and advantages of the exemplary embodiments of the present disclosure will become apparent upon reading the following detailed description of the exemplary embodiments of the present disclosure, when taken in conjunction with the appended paragraphs.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is an illustration providing exemplary size comparisons of cells, nanozymes, and the smart CMOS nanozymes, according to exemplary embodiments of the present disclosure;

FIG. 2 is a table providing exemplary cell volumes for human cells of various types, according to exemplary embodiments of the present disclosure;

FIG. 3 is a three-dimensional illustration of an exemplary smart CMOS nanozyme, according to an exemplary embodiment of the present disclosure;

FIG. 4 is at table providing data associated with various exemplary variants of an exemplary smart nanozyme design, according to another exemplary embodiment of the present disclosure, whereas HW meaning “hardwired,” and PG meaning “programmable”;

FIG. 5a is an exemplary flow diagram of the implementation of a conventional pH sensor;

FIG. 5b is an exemplary flow diagram of the implementation of an exemplary ISFET/REFET pH sensor, according to the exemplary embodiment of the present disclosure;

FIG. 6a is a three-dimensional representation of an exemplary functional implant having exemplary dimensions of about 30μm×30 μm×10 μm after release in solution, according to the exemplary embodiment of the present disclosure;

FIG. 6b is a plan view of the exemplary functional implant of FIG. 6a;

FIG. 6c is an expanded plan of the exemplary functional implant of FIGS. 6a and 6b illustrating various blown-up components;

FIG. 7a is a graph of an exemplary optically measured EOFM response, according to the exemplary embodiment of the present disclosure;

FIG. 7b is a graph of an exemplary PSD computed from a time trace, according to the exemplary embodiment of the present disclosure;

FIG. 8 is an exemplary illustration of 30 nm-scale particles brought into the central vacuole of N. scintillans, according to the exemplary embodiment of the present disclosure; and

FIG. 9 is a flow diagram of an exemplary path of electron flow in living systems, according to the exemplary embodiment of the present disclosure, whereas the exemplary flow applying to chemoorganoheterotrophic bacteria, although similar paths exist for other living systems, and whereas redox homeostasis is maintained by many redox couples acting as buffers in this chain, all of which can be acted upon by the smart nanozymes.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended paragraphs.

### DETAILED DESCRIPTION OF EXEMPLARY EMBODIMENTS

The following description of exemplary embodiments provides non-limiting representative examples referencing numerals to particularly describe features and teachings of different exemplary aspects and exemplary embodiments of the present disclosure. The exemplary embodiments described should be recognized as capable of implementation separately, or in combination, with other exemplary embodiments from the description of the exemplary embodiments. A person of ordinary skill in the art reviewing the description of the exemplary embodiments should be able to learn and understand the different described aspects of the present disclosure. The description of the exemplary embodiments should facilitate understanding of the exemplary embodiments of the present disclosure to such an extent that other implementations, not specifically covered but within the knowledge of a person of skill in the art having read the description of embodiments, would be understood to be consistent with an application of the exemplary embodiments of the present disclosure.

According to the exemplary embodiments of the present disclosure, smart active nanomaterials (which can be called “smart nanozymes”) that are CMOS integrated circuits, e.g., providing bioelectronics to the cellular and subcellular level, and facilitating new opportunities for these interfaces. For example, these chips are and/or include more than passive materials, which can be provided alongside or next to cells in a multicellular environment and/or reside inside of the cells. Such exemplary chips can sense, actuate, compute, and/or otherwise interact with the living system(s). Thus, according to the various exemplary embodiments of the present disclosure, it is possible to provide hybrid biotic-abiotic systems. While the exemplary smart nanozymes can be larger than typical nanozymes (for example, at 0.001 fL), such exemplary smart nanozymes can provide a number of significant advantages over both the passive nanozymes and engineered proteins.

Active. The exemplary smart nanozymes can couple via or in energy from various diverse sources and/or convert such energy from one form to another with exemplary active electronics performing the energy conversion. This contrasts with prior technology that includes nanozymes which can only catalyze reactions that are energetically favorable (e.g., in a Gibb's free energy sense).

Smart. The exemplary smart nanozymes can perform a computation to selectively drive reactions based on what is sensed, to have programmable function; and to communicate bidirectionally with and/or to an imaging device to control and report on this exemplary function.

Electrical. Various functions in the cell, including primary metabolism and signaling, are electrochemical in nature involving complex chains of electron transfer (e.g., redox reactions). Smart nanozymes according to the exemplary embodiments of the present disclosure can directly interact with this function regardless of reaction energetics and, as a result, directly affect the status of critical components of the physiology.

These exemplary devices according to the exemplary embodiments of the present disclosure can in some embodiments not be handled like ordinary integrated circuit chips, but are instead like a chemical reagent in suspension in a liquid.

A CMOS nanozyme device comprising:
a working electrode;
a counter electrode spaced from the working electrode;
a pH sensor configured to provide an indication of pH around the device;
   the pH sensor including an ion-sensitive field effect transistor; and
      a power source operable to provide electricity to the working electrode, counter electrode and pH sensor to sense or to actuate one or more chemical reactions,
      optionally wherein the CMOS nanozyme device has a volume of about 1 fL or less.

In some embodiments, the working electrode and the counter electrode operate to oxidize or reduce analytes at the working electrode.

In some embodiments, the working electrode is functionalized by one or more aptamers or peptides or antibodies or antibody fragments.

In some embodiments, pH modulation is provided based on a water splitting reaction at the working electrode and the counter electrode to provide hydrogen and oxygen ions.

In some embodiments, the CMOS nanozyme device further comprises a passivation layer, wherein the passivation layer provides an ion sensitive layer of an ion-sensitive field effect transistor that associates and dissociates protons as a function of pH to modulate a gate voltage of the field effect transistor with respect to a reference field effect transistor.

In some embodiments, the gate voltage may be used to control pH modulation.

In some embodiments, the power source is optical-based. In some embodiments, the device further comprises a photodiode. In some embodiments, the device receives information via amplitude-shift-keying of an optical signal. In some embodiments, the received information may include control information to control activation of the working electrode, counter electrode and pH sensor.

In some embodiments, the device further comprises a controller programmable using the control information to control activation of the working electrode, counter electrode and pH sensor.

In some embodiments, the device further comprises an electro-optic fluorescence modulator provided on a surface of the device to transmit information to a fluorescence microscope.

In some embodiments, the power source is electrochemical. In some embodiments, the device further comprises a layer of polydimethylsiloxane provided on at least one side of the device to provide an oxygen-permeable membrane.

In some embodiments, the power source is a glucose fuel cell comprising:
a porous platinum anode formed on a bottom surface of the device;
a CeO₂ electrolyte provided above the porous platinum anode; and
a dense platinum cathode provided above the CeO₂ electrolyte, wherein the dense platinum cathode is provided in contact with the bottom surface of the device;
wherein glucose reacts with water at the anode to provide gluconic acid and protons and electrons that pass through the electrolyte to the cathode such that the moving electrons provide electricity.

In some embodiments, the device is controlled using a closed-loop response based on actuation of molecular reactions and sensed information.

In some embodiments, the working electrode and the counter electrode provide a two-electrode potentiostat used to sense molecular reactions.

In some embodiments, the working electrode and the counter electrode provide a two-electrode potentiostat to drive chemical reactions.

In some embodiments, the device has a volume of 1 pL. In some embodiments, the device has a volume of about 1.5 pL. In some embodiments, the device has a volume of 5 pL. In some embodiments, the device a volume of about 9 pL.

In some embodiments, the device is implemented as a CMOS integrated circuit chip.

In some embodiments, one or more of the working electrode and counter electrode and the ion-sensitive field effect transistor include one or more molecules with desired binding properties on their surface to provide one or more targeted chemical reactions.

In some embodiments, one or more of the working electrode, counter electrodes and the ion-sensitive field effect transistor include enzymes integrated into a surface thereof.

A CMOS nanozyme device comprising:
a working electrode;
a counter electrode spaced from the working electrode;
an ion-sensitive field effect transistor; and
a power source operable to provide electricity to the working electrode, counter electrode and ion-sensitive field effect transistor.

A CMOS nanozyme device comprising:
a working electrode;
a counter electrode spaced from the working electrode;
an ion-sensitive field effect transistor as a sensor for pH, NH₃, CO₂, O₂, NO, or urea around the device; and
a power source operable to provide electricity to the working electrode, counter electrode and ion-sensitive field effect transistor to sense pH, NH₃, CO₂, O₂, NO, or urea or one or more chemical reactions.

In some embodiments, the chemical reaction is a redox reaction.

A CMOS nanozyme device comprising:
a working electrode;
a counter electrode spaced from the working electrode;
a temperature sensor to sense temperature around the device; and
a power source operable to provide electricity to the working electrode, counter electrode and temperature sensor.

In some embodiments, the temperature sensor is a field-effect transistor (FET) and temperature-dependent changes in the conductance of transistors are reviewed in the subthreshold regime.

An actuating CMOS nanozyme device comprising:
a potentiostat comprising a working electrode and a pseudo-reference electrode which effects oxidation or reduction of a predefined analyte at the working electrode.

In some embodiments of the devices, the CMOS nanozyme device can actuate the redox infrastructure of a cell in which it is present. In some embodiments, the CMOS nanozyme device can actuate cellular redox couples and reactive ion species (ROS), such as superoxide (O₂ ⁻), hydrogen peroxide (H₂O₂), and/or hydroxyl radicals (OH-).

In some embodiments, light energy is used to power and/or communicate with CMOS nanozyme device, allowing direct light-based programming and read-out.

In some embodiments, the CMOS nanozyme device has potentiostat functionality.

In some embodiments, CMOS nanozyme device may further comprising a reference FET, optionally a REFET.

In some embodiments, the CMOS recited herein is a FinFET CMOS.

In some embodiments, a composition is provided comprising a lipid microparticle (LMP) containing one or more devices or CMOS nanozymes as described herein. A method is provided comprising intracellular delivery one or more devices or CMOS nanozymes as described herein into a eukaryotic cell comprising contacting the cell with a composition comprising a lipid microparticle (LMP) containing one or more devices or CMOS nanozymes as described herein in order to effect intracellular delivery.

In embodiments, the cells as discussed herein are mammalian cells. In embodiments, the cells as discussed herein are human cells.

In some embodiments, the CMOS nanozyme or implantable active bioelectronics device has dimensions of no more than 10 μm in any one of its dimensions. In some embodiments, the CMOS nanozyme or implantable active bioelectronics device has dimensions of no more than 5 μm in any one of its dimensions. In some embodiments, the CMOS nanozyme or implantable active bioelectronics device has dimensions of no more than 3 μm in any one of its dimensions.

In some embodiments, the CMOS nanozyme or implantable active bioelectronics device has dimensions of about 10 μm by 10 μm by 10 μm. In some embodiments, the CMOS nanozyme or implantable active bioelectronics device has dimensions of less than 5 μm by 5 μm by 5 μm. In some embodiments, the CMOS nanozyme or implantable active bioelectronics device has dimensions of about 3 μm by 3 μm by 3 μm. In some embodiments, the CMOS nanozyme or implantable active bioelectronics device has dimensions of about 3 μm×3 μm×1 μm.

In some embodiments, the CMOS nanozyme or implantable active bioelectronics device has a volume of about 9 femtoliters. In some embodiments, the CMOS nanozyme or implantable active bioelectronics device has a volume of about 10 femtoliters. In some embodiments, the CMOS nanozyme or implantable active bioelectronics device has a volume of about 125 fL femtoliters. In some embodiments, the CMOS nanozyme or implantable active bioelectronics device has a volume of about 1000 femtoliters. In some embodiments, the CMOS nanozyme device has a volume of about 1000 fL or less. In some embodiments, the CMOS nanozyme device has a volume of about 100 fL or less. In some embodiments, the CMOS nanozyme device has a volume of about 8-20 fL. In some embodiments, the CMOS nanozyme device has a volume of about 9 fL.

In some embodiments, the CMOS circuits are built on a silicon substrate using layers of different materials to form transistors with a semiconductor (doped silicon), an oxide insulator (silicon dioxide), and metal (copper/aluminum) for connections.

Electrodes can be functionalized with aptamers. Sources of such aptamers can be found at, for example, on the world wide web at aptagen. com/apta-index/

Electrodes can be functionalized with antibodies or antigen-binding fragments thereof. Sources of such antibodies can be found at, for example, on the world wide web at citeab. com/antibodies/search

In embodiments, the CMOS nanozyme devices described herein are CMOS integrated circuit chips.

Enzymes functionalization can be employed in some embodiments, e.g., urease, HRP.

In some embodiments, Poly(p-styrenesulfonate) (PPSS) and/or graphene oxide may be employed as a coating for the ISFET. ISFET coatings for detection of NH₃ or NH₄⁺ are known in the art, e.g. nonactin ionophore embedded in a polymer membrane (in non-limiting examples, PVC, siloprene) and/or an NH₃-permebale gas membrane, or zeolite, fluropolysiloxane. Superoxides can be detected using, e.g., reduced graphene oxide (rGO), metal oxides (TiO₂, Ta₂O₅), or nanofibers (SiNW, In—Ga—Zn-—O) coatings. In some embodiments, tridodecylmethylammonium nitrate (TDDAN) may be used in a coating. Cao et al., (2022) hereby incorporated by reference, details ISFET coatings for purposes herein (see doi. org/10.1002/elsa.2021002). pH-sensitive ISFETs are known in the art. For CO₂, use is also known in the art and may employ, in some embodiments, PTFE or other permeable membrane, a bicarbonate buffer. O₂ detection via ISFET is also known and can include, in some embodiments, thin SnO₂ films.

DNA may also be detected by the devices described herein. Suitable coatings are known (e.g., see Table 3 of Cao et al., (2022) hereby incorporated by reference, doi. org/10.1002/elsa.2021002). Enzyme-based functionalization, which exists in some embodiments of the invention, are described in Table 4 of Cao et al., (2022) hereby incorporated by reference, doi. org/10.1002/elsa.2021002. Antibody functionalization can include using whole or antigen-binding fragments of antibodies, or scFvs thereof. Alternatively, antigens of said antibodies may be employed. See Table 5 of Cao et al., (2022) hereby incorporated by reference, doi.org/10.1002/elsa.2021002

A method of generating a reactive oxygen species in an extracellular or intracellular space comprising providing a nanozyme comprising a CMOS nanozyme device described herein in the extracellular or intracellular space.

In some embodiments, the reactive oxygen species is generated only when the nanozyme senses a predetermined analyte above a predefined threshold. In some embodiments, the analyte is intracellular temperature, pH, or the level of NH₃, CO₂, O₂, NO, or urea.

A method of sensing one or more physiological parameters, or change thereof, in an extracellular or intracellular space comprising providing a nanozyme comprising a CMOS integrated circuit chip described herein the extracellular or intracellular space.

In some embodiments, the method senses a parameter, or a change in said parameter, wherein the parameter is one or more of intracellular temperature, pH, NH₃, CO₂, O₂, NO, and urea.

In some embodiments, the method senses a parameter, or a change in said parameter, wherein the parameter is one or more of extracellular temperature, pH, NH₃, CO₂, O₂, NO, and urea.

In some embodiments, for the temperature sensing, temperature-dependent changes in the conductance of transistors are reviewed in the subthreshold regime. In some embodiments, for pH, NH₃, CO₂, O₂, NO, and urea sensing is done potentiometrically using one or more ion-sensitive field-effect transistors (ISFETs).

Described herein are two exemplary embodiments of the present disclosure, although it must be understood that the present disclosure and the various inventions described herein are certainly not limited to such exemplary embodiments.

### Exemplary SM (“Small”) and LG (“Large”) Designs

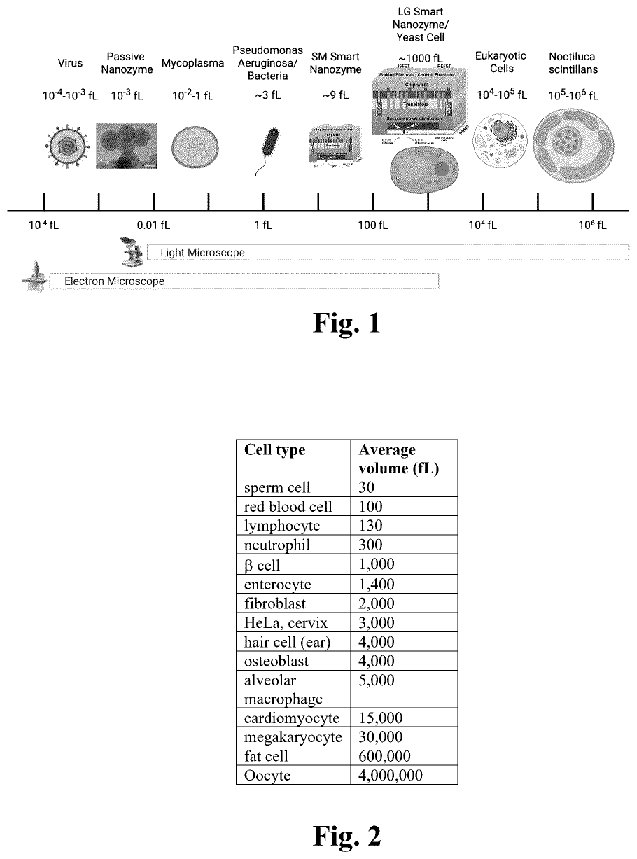

The exemplary SM design can have dimensions of, e.g., about 3 μm×3 μm×3 μm (a volume of 27 fL), the exemplary LG design can have dimensions of, e.g., about 10 μm ×10 μm ×10 μm (a volume of 1000 fL) The volumes of these smart nanozymes can be compared with typical cells as shown in FIG. 1. Most bacterial sizes range from 0.2 to 2.0μm in diameter and 2 to 8 μm in length. For example, Psuedomonas aeruginosa discussed herein is about 0.8 μm in diameter and up to 3 μm long. The exemplary volume of selected human cell types is shown in FIG. 2. The exemplary LG nanozymes can be the same size as a human β cell. The exemplary SM nanozyme can be 0.3% of this volume. Further therapeutic use in humans can be facilitated by the fact that these smart nanozymes would eventually dissolve in aqueous solution [see, e.g., Ref. 47], and be cleared by the body.

Exemplary smart nanozymes can prefer CMOS chip sizes to be down to the scale of 3 μm that still maintain the capability for a significant electronic function. This can be possible because of the various advances in the Moore's law scaling of semiconductors to nanometer-scale technology nodes. At the 3-μm scale, these exemplary chips can be small enough to be embedded in cellular communities and in lipid microparticles (LMPs) for intracellular delivery [see, e.g., Ref. 48]. LMPs' smaller counterparts, lipid nanoparticles (LNPs), have been used to deliver therapeutics to cells, including small molecules, peptides, mRNA, and proteins. The cell-targeting and tissue-targeting techniques employed with LNPs can be employed, according to the exemplary embodiments to the present disclosure.

According to various exemplary embodiments of the present disclosure, various principal applications can be employed for such exemplary smart CMOS nanozymes. For example, one such exemplary function can act as a sensors for temperature, pH, NH₃, O₂, CO₂, NO, urea, and redox active small molecules and peptides. Another exemplary function can be to actuate the redox infrastructure of cells including cellular redox couples and reactive ion species (ROS), such as superoxide (O₂⁻), hydrogen peroxide (H₂O₂), and hydroxyl radicals (OH⁻), that are the source of oxidative stress. The exemplary smart closed-loop function can also be pursued in which actuation will depend on what is sensed. Light can be used to power and communicate with some of these nanozyme designs allowing direct light-based programming and read-out. Other exemplary smart nanozymes can be, e.g., biochemically powered, and can function autonomously, acting as a kind of “artificial” cell.

### Exemplary Smart CMOS Nanozyme Design

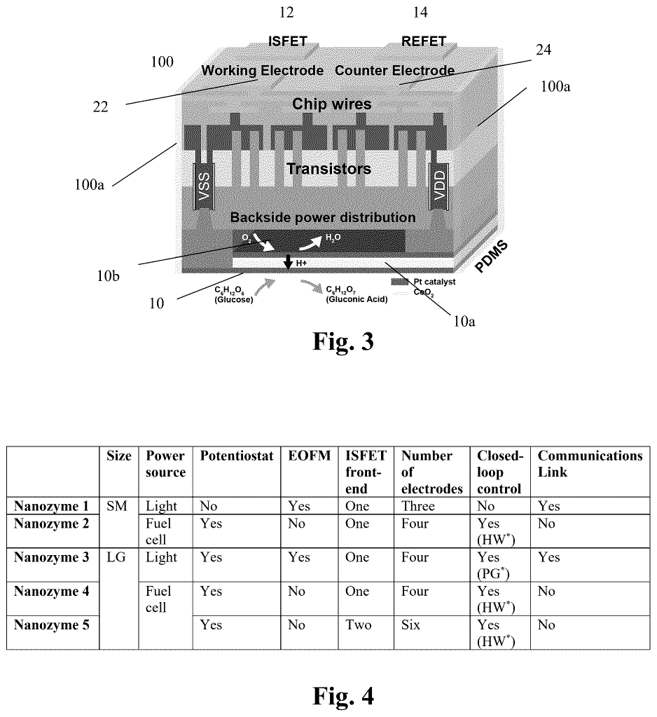

FIG. 3 shows an exemplary design of one exemplary smart CMOS nanozyme 100 discussed herein, which can provide the capabilities of active CMOS electronics to nanozymes. The exemplary CMOS nanozymes can employ the certain exemplary cutting-edge CMOS technologies that are employed in various advanced CPUs and GPUs containing more than, e.g., 100 billion transistors in chips 6 cm2 in area. It is possible to take advantage of such exemplary density, e.g., to make micron-scale chips while retaining significant electronic function. These exemplary CMOS nanozymes can be fabricated, e.g., in an advanced FinFET CMOS technology node.

Using the exemplary CMOS nanozymes and methods according to the exemplary embodiments of the present disclosure, up to 1000 transistors can be integrated onto a chip measuring only 3 μm×3 μm×3 μm in an embodiment of a small (SM) smart nanozyme. Powering devices at this scale can be challenging, and devices will operate on sub-μW power envelopes. Accordingly, it is possible to provide the exemplary smart nanozymes 100 according to further exemplary embodiments of the present disclosure that can operate on light, and other exemplary smart nanozymes according to still further exemplary embodiments of the present disclosure that can operate on biochemical energy sources. The exemplary smart nanozymes 100 according to such still further exemplary embodiments can directly utilize the backside power distribution in some advanced nodes.

Traditionally, power delivery and signal networks have been implemented with frontside wafer metallization. In the backside power distribution, the power delivery network is moved to wiring on the wafer backside with vias that connect to it through the thinned substrate [see, e.g., Ref. 89] as shown in FIG. 3. Achievable “thicknesses” for the CMOS nanozyme may be determined by the number of metal layers. In one example, only a small number may be needed for this application. For example, a number of exemplary variants of the exemplary smart nanozyme 100 may be provided, as shown in FIG. 4. Several such exemplary designs may have a closed-loop control between sensing and actuation, which may be accomplished with a small on-chip controller operating in deep subthreshold. In Nanozyme 3, the control will be programmable through light input. Within each of these exemplary nanozymes types, different variants may be provided with different redox potentials for exemplary variants that have potentiostat functionality in which the nanozyme is not programmable.

Powering. As shown in FIG. 4, certain possible exemplary sources of energy may be provided for these exemplary smart nanozymes, e.g., light and biochemical energy sources. For example, light provides the possibility for bidirectional communication with the nanozyme 100, as described herein, although access to light may be difficult for many biomedical applications, thus possibly requiring biochemical energy sources.

With respect to the exemplary light energy harvesting, backside illumination may be used and it may be assumed that an entire 3 μm×3 μm area for the SM design (or 10 μm×10 μm area for the large (LG) design) may be used for a photodiode. It is possible, according to various exemplary embodiments of the present disclosure, to make a p-n junction deep enough to capture light up to wavelengths in excess of 600 nm. Such exemplary photovoltaic cells are self-regulating under the bright light due to the logarithmic dependence of the open-circuit voltage on light intensity and are, therefore, relatively insensitive to light fluctuations at full “on” intensities. When clamped to a supply voltage of 0.4V, such the exemplary integrated photodiode is capable of generating, e.g., 126 nA of current at an incident optical power intensity of 8 mW/mm 2, for a harvested power of 50.4 nW (554 nW) for a SM (LG) nanozyme. At 1 mW/mm 2, e.g., the exemplary supply voltage may be about 6.3 nW (70 nW) for an exemplary SM (LG) CMOS nanozyme.

For the exemplary biochemical energy sources, the natural choice may be a glucose fuel cell 10 (see FIG. 3), since glucose is present ubiquitously extracellularly and intracellularly. Glucose fuel cells have typically relied on polymer-based proton-exchange membranes, such as, e.g., nafion, for anode-cathode separation. For example, the exemplary implementation may utilize ceria (CeO₂) as a ceramic proton-conducting electrolyte [see, e.g., Ref. 90]. These thin-films, which may be deposited by sputtering, have thicknesses on the order of, e.g., hundreds of nanometers, allowing them to be integrated on the CMOS nanozymes using standard semiconductor fabrication techniques [see, e.g., Ref. 91].

As shown in FIG. 3, the fuel cell 10 may include a porous-Pt-anode/CeO₂ electrolyte/dense-Pt-cathode multilayer stack 10a at thicknesses on the order of only a few hundred nanometers deposited on the backside, thus, taking advantage of the backside power distribution in Intel 18A. As described herein, an oxygen-permeable encapsulation of the sides of the nanozyme define a compartment 10b on the cathode side as shown in FIG. 3. The exemplary anode reaction is C₆H₁₂O₆+H₂O→C₆H₁₂O₇+2H⁺+2e⁻. The protons move through the proton-conducting electrolyte to react with oxygen at the cathode in the reaction (½)O₂+2H⁺+2e⁻→H₂O. The Gibbs free energy of the overall glucose-fuel-cell reaction, the reaction of glucose with oxygen to form gluconic acid, is ΔG⁰=−2.51×10⁵ J mol⁻¹, which results in an equilibrium Nernst potential of U⁰=1.08V [see, e.g., Ref. 92]. Typical glucose concentration extracellularly may be on the order of 3 mM, allowing a harvested energy on the order of 450 nW/mm², which may amount to a harvested power for the SM (LG) CMOS nanozyme of 4 nW (45 nW), comparable to the energy levels for light harvesting at 1 mW/mm² optical power.

Exemplary Power Management. Because the harvested voltages are on the scale of about 0.5 to 1 V, on-chip dc-dc conversion in the form of charge pumps or switch-capacitor converters (not shown) may be utilized to generate the larger potential required to operate the sensing and actuating functions. Such technology may be employed in other energy harvesting applications [see, e.g., Ref. 93]. Because of the extremely low power envelop, the CMOS nanozymes 100 may make a heavy use of subthreshold operation of transistors. All leakage currents may be carefully managed, e.g., likely more that are modeled in the device compact models. It is possible to rely on finite-element modelling of the device structures in the exemplary smart nanozyme and fabricate at least one test site for circuit characterization because of the limitation of the device models for this exemplary application.

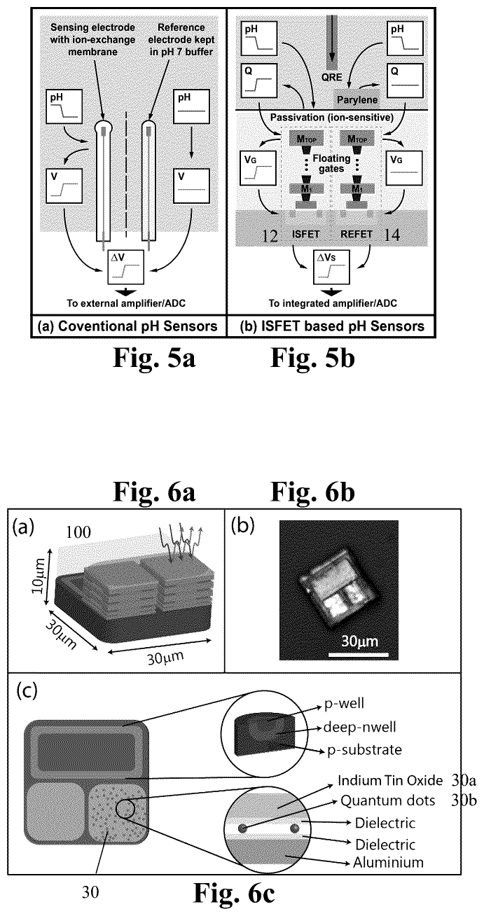

Exemplary Sensing (potentiometric) Functionality. for Sensing, it Is Possible to provide the ability to sense temperature, pH, NH₃, CO₂, O₂, NO, and urea, in addition to the intrinsic redox sensing capabilities of the potentiostat described below. For sensing temperature, temperature-dependent changes in the conductance of transistors may be reviewed in the subthreshold regime. The other sensing may be potentiometric using ion-sensitive field-effect transistors (ISFETs) 12. These exemplary sensors, which may utilize very low-power because of their use of subthreshold transistors, may use the change in the charge on an “ion-sensitive” layer connected to the transistor gate that may also be in contact with the target analyte. As indicated in a particular publication [see, e.g., Ref. 94], a robust, ultra-low power ISFET sensing front-end may be utilized that has been applied to pH sensing which may be employed with the exemplary embodiments of the present disclosure. ISFET devices [see, e.g., Ref. 95] may be paired with a reference FET (e.g., REFET) 14 to further increase the sensitivity for detection. For example, the exemplary ISFET/REFET design may be used for pH sensing in which the top passivation layer of the CMOS chip may be directly utilized as an ion-sensitive layer, as shown in FIG. 5b. This exemplary layer associates and dissociates with protons (H⁺) from an aqueous solution, thus creating a surface charge as a function of the pH. This charge further modulates the gate voltage V_{G} of the FET underneath with respect to an on-chip quasi reference electrode (QRE) in contact with the solution. The QRE may be shared with the potentiostat for those nanozyme designs integrating both.

For example, a number (e.g., 3) of electrodes on the chip surface may support this ISFET functionality. In addition to pH [see, e.g., Ref. 94], these ISFET sensors 12 may also be used for the other required sensing by a deposition of different sensing layers on the ISFET electrode 12. For example, ammonium may be detected by the addition of plasticized polyvinyl chloride [see, e.g., Ref. 96]. Urea may then be sensed by tethering urease to the ammonia sensors and take advantage of this reaction for detection:

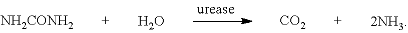

For oxygen, it is possible to use SnO₂ if it is combined with pH sensing in the Nanozyme 5 design. Because SnO₂ is an ion-sensitive layer sensitive to both pH and O₂ [see, e.g., Ref. 97], pH sensing should also be incorporated in the same nanozyme. To detect NO, a metalloporphyrin may be used as the ion-sensitive layer, e.g. preferably cobalt tetraphenylporphyrin [see, e.g., Ref. 98]. CO₂ may be sensed with hexyl-p-trifluoroacetylbenzoate as an ion-sensitive layer [see, e.g., Ref. 99].

Exemplary Actuation (amperometric) Functionality. For actuation, the device 100 may include a two-electrode (e.g., working and pseudo-reference) potentiostat that may be used to oxidize or reduce analytes at the working electrode. In this exemplary case, it is possible to drive reactions that would be otherwise unfavorable, moving beyond what is possible with passive nanozymes and catalysis. The working electrode 22 may be functionalized with aptamers, for example, to give the action of the CMOS nanozyme specificity in a manner similar to approaches used with passive nanozymes [see, e.g., Ref. 87]. pH modulation may also be possible with this exemplary system through water-splitting reactions [see, e.g., Ref. 100]. In acidic conditions, these reactions are 2H⁺+2e⁻→H₂ at the cathode and 2H₂O→O₂+4H⁺+4e⁻ at the anode. In basic conditions, these may become 4OH⁻→O₂+2H₂O+4e− at the anode and 2H₂O+2e⁻→H₂+2OH⁻ at the cathode. One of the challenges is the larger potential (energy) required for these reactions, generally greater than about 1.3 V. ROS may also be generated electrochemically in the same manner. For instance, the electrolysis of water may produce hydrogen peroxide and hydroxyl radicals, depending on the applied potential.

Exemplary back-of-the-envelope calculations may be made to access the power requirements and efficacy of these redox actuation capabilities. For example, the oxidation or reduction of phenazines extracellularly may be reviewed. Based on prior work with macroscale electrochemical interfaces to P. aeruginosa [see, e.g., Ref. 101, 102], typical phenazine concentrations are in the μM regime. Typical currents in the potentiostat as limited by diffusion to the electrode surface may be on the order of 10 nA for the LG nanozyme. This implies a power of approximately 5 nW to drive this reaction at the nanozyme, well within the power envelope of the LG design. At this rate of reduction or oxidation, if 10% of the volume is used by the exemplary LG nanozymes, then an oxidized or reduced phenazine concentration of, e.g., 0.1 pM may be produced. This exemplary concentration scales linearly with the number of nanozymes per unit volume and the redox current per nanozyme.

Exemplary Communications. For the exemplary CMOS nanozymes 100 using light for powering, it is possible to provide a bidirectional communication with the nanozymes in an epifluorescent microscope. To communicate information to the smart nanozyme 100, pulse-width modulation (PWM) or pulse-position modulation (PPM) of the incident light may be used to send bits of information to the CMOS nanozyme. There should be sufficient capacitive energy storage on the nanozyme to maintain powering in the “off’ light periods. Sending information back may be more complex, and should be accomplished with a “backscatter” approach for energy efficiency. It is possible to use a monolithically integrated quantum-confined-Stark-effect-(QCSE-) based electro-optic fluorescence modulator (EOFM) [see, e.g., Ref. 103] fabricated on the surface of the nanozyme. This EOFM 30 (see FIG. 6c) is a metal-insulator-metal (MIM) capacitor using transparent indium tin oxide 30a as the top contact. Within the high-κ dielectric of the MIM is embedded fluorescent quantum dots 30b. Applying an approximately 100 mV bias across the MIM capacitor modulated the fluorescence of the quantum dots, facilitating the CMOS nanozyme 100 to transmit information back to a fluorescent microscope.

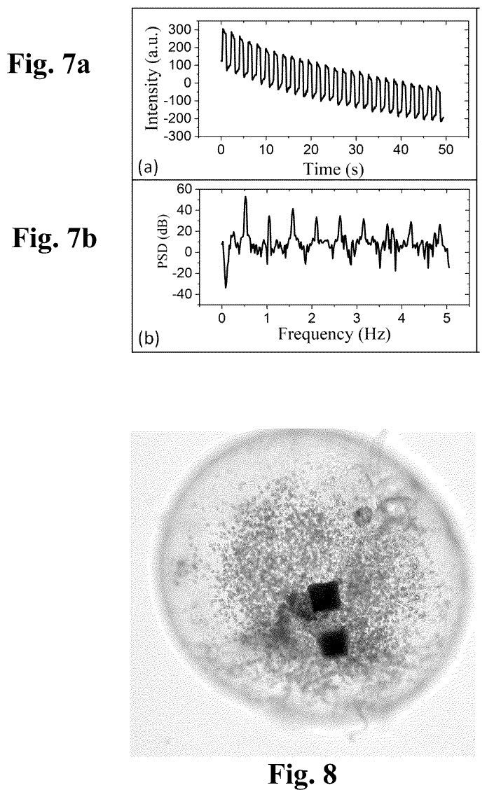

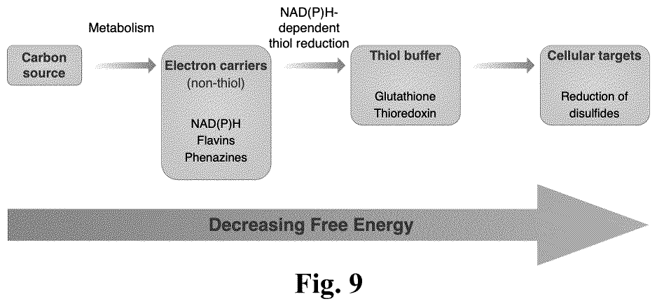

According to the exemplary embodiment of the present disclosure, and exemplary 30-μm-scale chip has been may be provided in a much-less-advanced 65-nm CMOS technology as shown in FIG. 6a that contains one of such exemplary EOFM devices connected to an on-chip gate-leakage relaxation oscillator [see, e.g., Ref. 104]. This exemplary chip may be powered optically with an on-chip photodiode. For example, two metal pads above the active electronics may form the foundation for the post-processed EOFM. FIG. 7 shows the exemplary measured modulation of the fluorescence of the OEFM. At a volume of, e.g., 9000 fL, this exemplary chip may be already the smallest autonomous electronic system ever created and still almost four orders of magnitude larger than the exemplary SM designs described herein with less function.

Exemplary Post-Processing. These exemplary advanced CMOS nodes may rely on extreme ultraviolet (EUV) photolithographic techniques to define the nanometer scale features on the chip. Such exemplary lithography capabilities may utilize an electron-beam (e-beam) lithography (direct write) for all the lithography required for post-processing. This may be performed even though e-beam lithography is not high-throughput, for the small volumes of chips. Exemplary post-processing steps will include fabrication of the EOFM (as discussed required), replacing electrode metals, trenching between dice on the chip, filling of the trenches with “side” passivation, further trenching of the passivation material, and backside thinning. In the exemplary case of the fuel cell designs, postprocessing of the ceria dielectric may be performed, e.g., on the back-side power distribution.

An exemplary die size may be 2 mm² on a multi-project wafer run (of which an exemplary wafer may produce 100 dice, since there would be 100 copies of the reticle in a single wafer). On such an exemplary die, it is possible to fit, e.g., approximately 40,000 LG nanozymes or 326,000 SM nanozymes. From a full wafer, this may be 0.05 fmol of the exemplary SM nanoenzymes. In large-scale manufacturing, in which an entire reticle could be dedicated to smart nanozyme manufacturing, an exemplary wafer may produce, e.g., 9.5 fmol of the exemplary SM nanoenzymes. This scale may be important to many of the applications; it may be preferrable for these nanozymes to exist in numbers (like cells), measured in moles, such that their aggregate effect is large enough on the biological cells being studied.

Exemplary Passivation. For the fuel-cell nanozymes 100 (as shown in FIG. 3), It may be preferrable to passivate the sides of the nanozyme with PDMS 100a to act as an oxygen permeable membrane. One of the challenges to this may be the need to encapsulate water in the cathode compartment, also such similar challenges have been overcome in the exemplary solid-state nanopore efforts [see, e.g., Refs. 52 and 105]. Otherwise, these nanozymes 100 may be left unpassivated. For potential biomedical applications, it is possible to consider how such exemplary smart nanozymes may be cleared by the body. Recent studies have shown that microplastics are present in many body fluids including whole blood with particle sized up to a few microns is size [see, e.g., Ref. 106]. Unlike these microplastics, the exemplary smart nanozymes, if left unpassivated, will eventually dissolve in aqueous solution [see, e.g., Ref. 47] and be cleared by the body. Important materials in conventional CMOS, including tungsten, silicon, and silicon dioxide, eventually dissolve in water.

Electrode functionalization. One of the important features that natural enzymes have may be a specificity of function in their catalysis, which may be important to preserve in the smart nanozymes. This may be accomplished in the following exemplary ways:
Incorporation of molecular recognition elements. Molecules that exhibit specific binding properties, such as aptamers, antibodies, or specially designed synthetic receptors, may be immobilized on electrode surfaces of the ISFET 12, REFET 14, working electrode 22 and counter electrode 24. These molecules may selectively capture specific substrates from a mixture, bringing them into close proximity with the electrode for targeted electrochemical reactions. This may also help to concentrate target analytes at the smart nanozyme. DNA aptamers may be favored here [see, e.g., Ref. 107] because of the stability of these molecules compared to antibodies.
Use of enzyme-modified electrodes. Direct integration of enzymes onto electrode surfaces of the ISFET 12, REFET 14, working electrode 22 and counter electrode 24, combines the specificity of enzymatic catalysis with electrochemical methods. In such bioelectrochemical systems, the enzyme retains its substrate specificity, and the electrode provides the necessary redox potential to drive the reaction. In this exemplary way, the enzymes may also function as redox mediators. One example may be the use of metalloporphyrins to specifically reduce nitrite to NO.

Delivery. Smart nanozymes 100 will be stored and delivered in suspension. We expect that long-term storage will be in solvent and that this will be converted to aqueous suspensions close to use. Nanozymes 100 may be treated as any other reagent suspension, allowing them to be mixed in cell cultures. In eventual biomedical applications, they may also be delivered in body tissues through an injection. Functionalization of the nanozymes may also be used to direct these smart nanozymes to particular cells as is done with passive nanozymes. For intracellular delivery of the smart nanozymes 100, encapsulation in LMPs may be considered. The much larger size of the smart nanozymes 100 may present some challenges. Much larger particles (e.g., on the order of about 30 μm) are brought into the cell endocytotically through food vacuoles that, in turn, merge into the central vacuole (see FIG. 8). The same should hold for the smaller smart nanozymes.

### Exemplary Uses for Smart Cmos Nanozymes

The following ways may be employed in which these exemplary smart CMOS nanozymes 100 interact with living systems, which may mirror efforts with passive nanozymes but with significantly enhanced capabilities. For example, the smart CMOS nanozymes 100 may be provided in or be a sensor (using the optical-interfacing Nanozymes 1 and 3 shown in FIG. 4). Further, it is possible to perform redox-based regulation with such exemplary nanozymes. Controlling oxidative stress and restoring redox homeostasis has application in treatment of inflammation, cancer, and cardiovascular disease.

Exemplary Oxidative stress and redox homeostasis. Cellular function depends on the coupling of electron-transfer reactions to the generation of adenosine triphosphate (ATP) for energy. Many complex redox balances are maintained within the cell. These reactions depend on a chain of electron carriers in the cell as shown in FIG. 8 that ultimately lead to the reduction of disulfide bonds in cysteine residues in cytoplasmic proteins [see, e.g., Ref. 3] in the presence of oxidative stress. This stress may result from an exposure to ROS, which are generated primarily as a consequence of cellular metabolism [see, e.g., Refs. 108-118]. The cell may also explicitly generate ROS by the action of the NOX/DUOX family of membrane-bound nicotinamide adenine dinucleotide phosphate (NADPH)-dependent oxidases [see, e.g., Ref. 119, 120], which catalyze the transfer of electrons from NADPH onto oxygen molecules.

Redox-active small molecules have an important role in maintaining redox homeostasis, including thioredoxin and the low-molecular weight thiol glutathione. In both cases, electrons from NADPH or NADH are used reduce a disulfide bond to drive these small peptides into their reduced form (see FIG. 8). NAD(P)(H) is an electron donor or acceptor in many critical energy-generating and anabolic reactions, acting as a cellular redox buffer, interfacing with other redox active molecules such as phenazines, quinones, and flavins. Both redox-active metabolites and ROS may be detected by sensory proteins in cells to control cellular activity. One of the notable of such exemplary sensors may be the transcription factor SoxR [see, e.g., Ref. 121] (superoxide response) in bacteria, but such the sensors also exist in eukaryotes.

For example, it is often assumed that, in humans, every cellular pathway has at least one redox-sensitive element [see, e.g., Ref. 3], giving redox reactions great control over cellular function. The exemplary smart nanozymes 100, by directly interfacing to this redox machinery, including the direct generation of ROS and the control of pH, may yield a significant control over cell physiology. Unlike passive nanozymes, reactions will not be limited by Gibbs-free-energy considerations. Using aptamers that distinguish the oxidized and reduced forms of glutathione [see, e.g., Ref. 122], smart nanozymes 100, for example, may control the redox state of this thiol.

Sensing and closed-loop control. The exemplary sensing capabilities may be linked to optical read-out for Nanozymes 1 and 3. For all nanozymes, except Nanozyme 1, it is possible to control the redox actuation based on sensor input. Once the nanozyme senses a condition define by sensing an analyte above a predefined threshold, it may activate and carry out its designed electrochemical reaction. For example, in Nanozyme 3, this function may be programmed optically.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one exemplary embodiment,” or “in one implementation” does not necessarily refer to the same example, exemplary embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended numbered paragraphs. Although specific terms are employed herein, they are used in a generic and descriptive sense only and not for purposes of limitation.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and may be thus within the spirit and scope of the disclosure. Various different exemplary embodiments may be used together with one another, as well as interchangeably therewith, as should be understood by those having ordinary skill in the art. In addition, certain terms used in the present disclosure, including the specification and drawings, may be used synonymously in certain instances, including, but not limited to, for example, data and information. It should be understood that, while these words, and/or other words that may be synonymous to one another, may be used synonymously herein, that there may be instances when such words may be intended to not be used synonymously. Further, to the extent that the prior art knowledge has not been explicitly incorporated by reference herein above, it is explicitly incorporated herein in its entirety. All publications referenced are incorporated herein by reference in their entireties.

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the numbered paragraphs, and may include other examples that occur to those skilled in the art. Such other examples are intended to be within the scope of the numbered paragraphs if they have structural elements that do not differ from the literal language of the numbered paragraphs, or if they include equivalent structural elements with insubstantial differences from the literal language of the numbered paragraphs

### References

The following reference is hereby incorporated by references, in their entireties:
1. Mehlen, P. and A. Puisieux, Metastasis: a question of life or death. Nat Rev Cancer, 2006. 6(6): p. 449-58.
2. Hirahata, T., R. ul Quraish, A. u. Quraish, S. ul Quraish, M. Naz, and M. A. Razzaq, Liquid biopsy: a distinctive approach to the diagnosis and prognosis of cancer. Cancer informatics, 2022. 21: p. 11769351221076062.
3. Song, P., L. R. Wu, Y. H. Yan, J. X. Zhang, T. Chu, L. N. Kwong, A. A. Patel, and D. Y. Zhang, Limitations and opportunities of technologies for the analysis of cell-free DNA in cancer diagnostics. Nature biomedical engineering, 2022. 6(3): p. 232-245.
4. Gao, Y., J. Wang, Y. Zhou, S. Sheng, S. Y. Qian, and X. Huo, Evaluation of Serum CEA, CA19-9, CA72-4, CA125 and Ferritin as Diagnostic Markers and Factors of Clinical Parameters for Colorectal Cancer. Scientific Reports, 2018. 8(1): p. 2732.
5. Castaneda, M., P. den Hollander, N. A. Kuburich, J. M. Rosen, and S. A. Mani, Mechanisms of cancer metastasis. Semin Cancer Biol, 2022. 87: p. 17-31.
6. Fares, J., M. Y. Fares, H. H. Khachfe, H. A. Salhab, and Y. Fares, Molecular principles of metastasis: a hallmark of cancer revisited. Signal Transduct Target Ther, 2020. 5(1): p. 28.
7. Tang, C. M. and D. L. Adams, Clinical Applications of Cancer-Associated Cells Present in the Blood of Cancer Patients. Biomedicines, 2022. 10(3).
8. Yu, M., S. Stott, M. Toner, S. Maheswaran, and D. A. Haber, Circulating tumor cells: approaches to isolation and characterization. Journal of Cell Biology, 2011. 192(3): p. 373-382.
9. Cohen, S. J., C. J. Punt, N. Iannotti, B. H. Saidman, K. D. Sabbath, N. Y. Gabrail, J. Picus, M. Morse, E. Mitchell, and M.C. Miller, Relationship of circulating tumor cells to tumor response, progression-free survival, and overall survival in patients with metastatic colorectal cancer. Journal of clinical oncology, 2008. 26(19): p. 3213-3221.
10. Bidard, F.-C., W. Jacot, N. Kiavue, S. Dureau, A. Kadi, E. Brain, T. Bachelot, H. Bourgeois, A. Gonçalves, and S. Ladoire, Efficacy of circulating tumor cell count-driven vs clinician-driven first-line therapy choice in hormone receptor-positive, ERBB2-negative metastatic breast cancer: The STIC CTC randomized clinical trial. JAMA oncology, 2021. 7(1): p. 34-41.
11. Cabel, L., F. Berger, P. Cottu, D. Loirat, A. Rampanou, E. Brain, S. Cyrille, H. Bourgeois, N. Kiavue, and E. Deluche, Clinical utility of circulating tumour cell-based monitoring of late-line chemotherapy for metastatic breast cancer: the randomised CirCe01 trial. British Journal of Cancer, 2021. 124(7): p. 1207-1213.
12. Smerage, J. B., W. E. Barlow, G. N. Hortobagyi, E. P. Winer, B. Leyland-Jones, G. Srkalovic, S. Tejwani, A.F. Schott, M.A. O'Rourke, and D. L. Lew, Circulating tumor cells and response to chemotherapy in metastatic breast cancer: SWOG S0500. Journal of Clinical Oncology, 2014. 32(31): p. 3483-3489.
13. Sutton, T. L., B. S. Walker, and M. H. Wong, Circulating Hybrid Cells Join the Fray of Circulating Cellular Biomarkers. Cell Mol Gastroenterol Hepatol, 2019. 8(4): p. 595-607.
14. Adams, D. L., S. S. Martin, R. K. Alpaugh, M. Charpentier, S. Tsai, R. C. Bergan, I. M. Ogden, W. Catalona, S. Chumsri, and C.-M. Tang, Circulating giant macrophages as a potential biomarker of solid tumors. Proceedings of the National Academy of Sciences, 2014. 111(9): p. 3514-3519.
15. Aguirre, L. A., K. Montalbán-Hernández, J. Avendaño-Ortiz, E. Marín, R. Lozano, V. Toledano, L. Sánchez-Maroto, V. Terrón, J. Valentín, and E. Pulido, Tumor stem cells fuse with monocytes to form highly invasive tumor-hybrid cells. Oncoimmunology, 2020. 9(1): p. 1773204.
16. Augustyn, A., D. L. Adams, J. He, Y. Qiao, V. Verma, Z. Liao, C.-M. Tang, J. V. Heymach, A. S. Tsao, and S. H. Lin, Giant circulating cancer-associated macrophage-like cells are associated with disease recurrence and survival in non-small-cell lung cancer treated with chemoradiation and atezolizumab. Clinical Lung Cancer, 2021. 22(3): p. e451-e465.
17. Chou, C.-W., C.-N. Hung, C. H.-L. Chiu, X. Tan, M. Chen, C.-C. Chen, M. Saeed, C.-W. Hsu, M. A. Liss, and C.-M. Wang, Phagocytosis-initiated tumor hybrid cells acquire a c-Myc-mediated quasi-polarization state for immunoevasion and distant dissemination. Nature communications, 2023. 14(1): p. 6569.
18. Clawson, G. A., G. L. Matters, P. Xin, C. McGovern, E. Wafula, C. DePamphilis, M. Meckley, J. Wong, L. Stewart, and C. D'Jamoos, “Stealth dissemination” of macrophage-tumor cell fusions cultured from blood of patients with pancreatic ductal adenocarcinoma. PLoS One, 2017. 12(9): p. e0184451.
19. Dietz, M. S., T. L. Sutton, B. S. Walker, C. E. Gast, L. Zarour, S. K. Sengupta, J. R. Swain, J. Eng, M. Parappilly, and K. Limbach, Relevance of circulating hybrid cells as a non-invasive biomarker for myriad solid tumors. Scientific Reports, 2021. 11(1): p. 13630.
20. Gast, C. E., A. D. Silk, L. Zarour, L. Riegler, J. G. Burkhart, K. T. Gustafson, M. S. Parappilly, M. Roh-Johnson, J. R. Goodman, and B. Olson, Cell fusion potentiates tumor heterogeneity and reveals circulating hybrid cells that correlate with stage and survival. Science advances, 2018. 4(9): p. eaat7828.
21. Gironda, D. J., D. L. Adams, J. He, T. Xu, H. Gao, Y. Qiao, R. Komaki, J. M. Reuben, Z. Liao, and M. Blum-Murphy, Cancer associated macrophage-like cells and prognosis of esophageal cancer after chemoradiation therapy. Journal of translational medicine, 2020. 18: p. 1-9.
22. Hass, R., J. von der Ohe, and T. Dittmar, Hybrid formation and fusion of cancer cells in vitro and in vivo. Cancers, 2021. 13(17): p. 4496.
23. LaBerge, G., E. Duvall, Z. Grasmick, K. Haedicke, A. Galan, and J. Pawelek, A melanoma patient with macrophage-cancer cell hybrids in the primary tumor, a lymph node metastasis and a brain metastasis. Cancer Genetics, 2021. 256: p. 162-164.
24. Manjunath, Y., J. B. Mitchem, K. N. Suvilesh, D. M. Avella, E. T. Kimchi, K. F. Staveley-O'Carroll, C. B. Deroche, K. Pantel, G. Li, and J. T. Kaifi, Circulating giant tumor-macrophage fusion cells are independent prognosticators in patients with NSCLC. Journal of Thoracic Oncology, 2020. 15(9): p. 1460-1471.
25. Moein, S., R. Adibi, L. da Silva Meirelles, N. B. Nardi, and Y. Gheisari, Cancer regeneration: Polyploid cells are the key drivers of tumor progression. Biochimica et Biophysica Acta (BBA)—Reviews on Cancer, 2020. 1874(2): p. 188408.
26. Mu, Z., C. Wang, Z. Ye, G. Rossi, C. Sun, L. L i, Z. Zhu, H. Yang, and M. Cristofanilli, Prognostic values of cancer associated macrophage-like cells (CAML) enumeration in metastatic breast cancer. Breast Cancer Research and Treatment, 2017. 165(3): p. 733-741.
27. Nehme, Z., S. Pasquereau, S. Haidar Ahmad, A. Coaquette, C. Molimard, F. Monnien, M.-P. Algros, O. Adotevi, M. Diab Assaf, J.-P. Feugeas, and G. Herbein, Polyploid giant cancer cells, stemness and epithelial-mesenchymal plasticity elicited by human cytomegalovirus. Oncogene, 2021. 40(17): p. 3030-3046.
28. Sieler, M., J. Weiler, and T. Dittmar, Cell-Cell Fusion and the Roads to Novel Properties of Tumor Hybrid Cells. Cells, 2021. 10(6): p. 1465.
29. Ali, A. M. and A. Raza, scRNAseq and High-Throughput Spatial Analysis of Tumor and Normal Microenvironment in Solid Tumors Reveal a Possible Origin of Circulating Tumor Hybrid Cells. Cancers, 2024. 16(7): p. 1444.
30. Sutton, T. L., R. K. Patel, A. N. Anderson, S. G. Bowden, R. Whalen, N. R. Giske, and M. H. Wong, Circulating cells with macrophage-like characteristics in cancer: the importance of circulating neoplastic-immune hybrid cells in cancer. Cancers, 2022. 14(16): p. 3871.
31. Walker, B. S., T. L. Sutton, L. Zarour, J. G. Hunter, S. G. Wood, V. L. Tsikitis, D. O. Herzig, C. D. Lopez, E. Y. Chen, and S. C. Mayo, Circulating hybrid cells: a novel liquid biomarker of treatment response in gastrointestinal cancers. Annals of surgical oncology, 2021. 28(13): p. 8567-8578.
32. Wang, L., P. Balasubramanian, A. P. Chen, S. Kummar, Y. A. Evrard, and R. J. Kinders, Promise and limits of the CellSearch platform for evaluating pharmacodynamics in circulating tumor cells. Semin Oncol, 2016. 43(4): p. 464-75.
33. Wang, L., P. Balasubramanian, A. P. Chen, S. Kummar, Y. A. Evrard, and R. J. Kinders. Promise and limits of the CellSearch platform for evaluating pharmacodynamics in circulating tumor cells. in Seminars in oncology. 2016. Elsevier.
34. Sollier, E., D. E. Go, J. Che, D. R. Gossett, S. O'Byrne, W. M. Weaver, N. Kummer, M. Rettig, J. Goldman, and N. Nickols, Size-selective collection of circulating tumor cells using Vortex technology. Lab on a Chip, 2014. 14(1): p. 63-77.
35. Di Trapani, M., N. Manaresi, and G. Medoro, DEPArray™ system: an automatic image-based sorter for isolation of pure circulating tumor cells. Cytometry Part A, 2018. 93(12): p. 1260-1266.
36. Fischer, J. C., D. Niederacher, S. A. Topp, E. Honisch, S. Schumacher, N. Schmitz, L. Zacarias Fohrding, C. Vay, I. Hoffmann, N. S. Kasprowicz, P. G. Hepp, S. Mohrmann, U. Nitz, A. Stresemann, T. Krahn, T. Henze, E. Griebsch, K. Raba, J. M. Rox, F. Wenzel, C. Sproll, W. Janni, T. Fehm, C. A. Klein, W. T. Knoefel, and N.H. Stoecklein, Diagnostic leukapheresis enables reliable detection of circulating tumor cells of nonmetastatic cancer patients. Proc Natl Acad Sci USA, 2013. 110(41): p. 16580-5.
37. Vermesh, O., A. Aalipour, T. J. Ge, Y. Saenz, Y. Guo, I. S. Alam, S.-m. Park, C. N. Adelson, Y. Mitsutake, and J. Vilches-Moure, An intravascular magnetic wire for the high-throughput retrieval of circulating tumour cells in vivo. Nature biomedical engineering, 2018. 2(9): p. 696-705.
38. Kim, T. H., Y. Wang, C. R. Oliver, D. H. Thamm, L. Cooling, C. Paoletti, K. J. Smith, S. Nagrath, and D. F. Hayes, A temporary indwelling intravascular aphaeretic system for in vivo enrichment of circulating tumor cells. Nature communications, 2019. 10(1): p. 1478.
39. Burinaru, T. A., B. Adiaconiţă, M. Avram, P. Preda, A.-M. Enciu, E. Chiriac, C. Mărculescu, T. Constantin, and M. Militaru, Electrochemical impedance spectroscopy based microfluidic biosensor for the detection of circulating tumor cells. Materials Today Communications, 2022. 32: p. 104016.
40. Chen, Y., C. C. Wong, T. S. Pui, R. Nadipalli, R. Weerasekera, J. Chandran, H. Yu, and A. R. Rahman, CMOS high density electrical impedance biosensor array for tumor cell detection. Sensors and Actuators B: Chemical, 2012. 173: p. 903-907.
41. Levine, P. M., P. Gong, R. Levicky, and K. L. Shepard, Real-time, multiplexed electrochemical DNA detection using an active complementary metal-oxide-semiconductor biosensor array with integrated sensor electronics. Biosensors and Bioelectronics, 2009. 24(7): p. 1995-2001.
42. Levine, P. M., P. Gong, K. L. Shepard, and L. R. Active CMOS array for electrochemical sensing of biomolecules. in IEEE Custom Integrated Circuits Conference. 2007.
43. Levine, P. M., G. Ping, R. Levicky, and K. L. Shepard, Active CMOS Sensor Array for Electrochemical Biomolecular Detection. Solid-State Circuits, IEEE Journal of, 2008. 43(8): p. 1859-1871.
44. Chen, J., C. Xue, Y. Zhao, D. Chen, M.-H. Wu, and J. Wang, Microfluidic impedance flow cytometry enabling high-throughput single-cell electrical property characterization. International journal of molecular sciences, 2015. 16(5): p. 9804-9830.
45. Gawad, S., L. Schild, and P. Renaud, Micromachined impedance spectroscopy flow cytometer for cell analysis and particle sizing. Lab on a Chip, 2001. 1(1): p. 76-82.
46. Feng, Y., L. Huang, P. Zhao, F. Liang, and W. Wang, A Microfluidic Device Integrating Impedance Flow Cytometry and Electric Impedance Spectroscopy for High-Efficiency Single-Cell Electrical Property Measurement. Analytical Chemistry, 2019. 91(23): p. 15204-15212.
47. Cheung, K. C., M. Di Berardino, G. Schade-Kampmann, M. Hebeisen, A. Pierzchalski, J. Bocsi, A. Mittag, and A. Tárnok, Microfluidic impedance-based flow cytometry. Cytometry Part A, 2010. 77A(7): p. 648-666.
48. Desai, S. P., A. Coston, and A. Berlin, Micro-electrical impedance spectroscopy and identification of patient-derived, dissociated tumor cells. IEEE transactions on nanobioscience, 2019. 18(3): p. 369-372.
49. Gajasinghe, R. W., O. Tigli, M. Jones, and T. Ince. Label-free tumor cell detection and differentiation based on electrical impedance spectroscopy. in 2016 IEEE SENSORS. 2016. IEEE.
50. Zhao, Y., X. Zhao, D. Chen, Y. Luo, M. Jiang, C. Wei, R. Long, W. Yue, J. Wang, and J. Chen, Tumor cell characterization and classification based on cellular specific membrane capacitance and cytoplasm conductivity. Biosensors and Bioelectronics, 2014. 57: p. 245-253.
51. Lee, E. W., S. Thai, and S. T. Kee, Irreversible electroporation: a novel image-guided cancer therapy. Gut Liver,2010. 4 Suppl 1(Suppl 1): p. S99-s104.
52. Miller, L., J. Leor, and B. Rubinsky, Cancer Cells Ablation with Irreversible Electroporation. Technology in Cancer Research & Treatment, 2005. 4(6): p. 699-705.
53. Rubinsky, J., G. Onik, P. Mikus, and B. Rubinsky, Optimal Parameters for the Destruction of Prostate Cancer Using Irreversible Electroporation. The Journal of Urology, 2008. 180(6): p. 2668-2674.
54. Cvetković, D. M., M. N. Z̆ivanović, M. G. Milutinović, T. R. Djukić, M.D. Radović, A. M. Cvetković, N. D. Filipović, and N. D. Zdravković, Real-time monitoring of cytotoxic effects of electroporation on breast and colon cancer cell lines. Bioelectrochemistry, 2017. 113: p. 85-94.
55. Geboers, B., H. J. Scheffer, P. M. Graybill, A. H. Ruarus, S. Nieuwenhuizen, R. S. Puijk, P. M. van den Tol, R. V. Davalos, B. Rubinsky, T. D. de Gruijl, D. Miklavc̆ic̆, and M. R. Meijerink, High-Voltage Electrical Pulses in Oncology: Irreversible Electroporation, Electrochemotherapy, Gene Electrotransfer, Electrofusion, and Electroimmunotherapy. Radiology, 2020. 295(2): p. 254-272.
56. Rolong, A., E. M. Schmelz, and R. V. Davalos, High-frequency irreversible electroporation targets resilient tumor-initiating cells in ovarian cancer. Integrative Biology, 2017. 9(12): p. 979-987.
57. Ringel-Scaia, V. M., N. Beitel-White, M. F. Lorenzo, R. M. Brock, K. E. Huie, S. Coutermarsh-Ott, K. Eden, D.K. McDaniel, S. S. Verbridge, J. H. Rossmeisl, Jr., K. J. Oestreich, R. V. Davalos, and I. C. Allen, High-frequency irreversible electroporation is an effective tumor ablation strategy that induces immunologic cell death and promotes systemic anti-tumor immunity. eBioMedicine, 2019. 44: p. 112-125.
58. Jung, T., N. Zeng, J. D. Fabbri, G. Eichler, Z. Li, K. Willeke, K. E. Wingel, A. Dubey, R. Huq, M. Sharma, Y. Hu, G. Ramakrishnan, K. Tien, P. Mantovani, A. Parihar, H. Yin, D. Oswalt, A. Misdorp, I. Uguz, T. Shinn, G. J. Rodriguez, C. Nealley, I. Gonzales, M. Roukes, J. Knecht, D. Yoshor, P. Canoll, E. Spinazzi, L. P. Carloni, B. Pesaran, S. Patel, B. Youngerman, R. J. Cotton, A. Tolias, and K. L. Shepard, Stable, chronic in-vivo recordings from a fully wireless subdural-contained 65,536-electrode brain-computer interface device. bioRxiv, 2024: p. 2024.05.17.594333.
59. Zeng, N., T. Jung, M. Sharma, G. Eichler, F. Fabbri, R. J. Cotton, E. Spinazzi, B. Youngerman, L. Carloni, and K. L. Shepard, A Wireless, Mechanically Flexible, 25 m-Thick, 65,536-Channel Subdural Surface Recording and Stimulating Microelectrode Array with Integrated Antennas, in Symposium on VLSI Circuit. 2023.
60. Wang, H., Z. Zhang, Y. Li, and Z. Feng, A Wideband Differential-Fed Slot Antenna Using Integrated Compact Balun With Matching Capability. IEEE Transactions on Antennas and Propagation, 2014. 62(10): p. 5394-5399.
61. Kuster, N., V. Santomaa, and A. Drossos, The dependence of electromagnetic energy absorption upon human head tissue composition in the frequency range of 300-3000 MHz. IEEE Transactions on Microwave Theory and Techniques, 2000. 48(11): p. 1988-1995.
62. Andreuccetti, D., R. Fossi, and C. Petrucci, An Internet resource for the calculation of the dielectric properties of body tissues in the frequency range 10 Hz- 100 GHz. 1997: IFAC-CNR, Florence (Italy).
63. Mei-Chao, Y., L. Ren-Chieh, T. Zuo-Min, and H. Wang, A miniature low-insertion-loss, high-power CMOS SPDT switch using floating-body technique for 2.4-and 5.8-GHz applications, in 2005 IEEE Radio Frequency integrated Circuits (RFIC) Symposium—Digest of Papers. 2005. p. 451-454.
64. Dokania, R., X. Wang, S. Tallur, C. Dorta-Quinones, and A. Apsel, An Ultralow-Power Dual-Band UWB Impulse Radio. IEEE Transactions on Circuits and Systems II: Express Briefs, 2010. 57(7): p. 541-545.
65. Vigraham, B. and P. R. Kinget, A Self-Duty-Cycled and Synchronized UWB Pulse-Radio Receiver SoC With Automatic Threshold-Recovery Based Demodulation. IEEE Journal of Solid-State Circuits, 2014. 49(3): p. 581-594.
66. Tiuraniemi, S., L. Stoica, A. Rabbachin, and I. Oppermann, Front-End Receiver for Low Power, Low Complexity Non-Coherent UWB Communications System, in 2005 IEEE International Conference on Ultra-Wideband. 2005. p. 339-343.
67. Witrisal, K., G. Leus, G. J. M. Janssen, M. Pausini, F. Troesch, T. Zasowski, and J. Romme, Noncoherent ultra-wideband systems. IEEE Signal Processing Magazine, 2009. 26(4): p. 48-66.
68. Humblet, P. A. and M. Azizoglu, On the bit error rate of lightwave systems with optical amplifiers. Journal of Lightwave Technology, 1991. 9(11): p. 1576-1582.
69. Federal Communications Commission (FCC), 47 CFR Part 15 Subpart F Ultra-Wideband Operation. 2002.
70. Lee, G., J. Park, J. Jang, T. Jung, and T. W. Kim, An IR-UWB CMOS Transceiver for High-Data-Rate, Low-Power, and Short-Range Communication. IEEE Journal of Solid-State Circuits, 2019. 54(8): p. 2163-2174.
71. Montanaro, J., R. T. Witek, K. Anne, A. J. Black, E. M. Cooper, D. W. Dobberpuhl, P. M. Donahue, J. Eno, W. Hoeppner, D. Kruckemyer, T. H. Lee, P. C. M. Lin, L. Madden, D. Murray, M. H. Pearce, S. Santhanam, K. J. Snyder, R. Stehpany, and S. C. Thierauf, A 160-MHz, 32-b, 0.5-W CMOS RISC microprocessor. Solid-State Circuits, IEEE Journal of, 1996. 31(11): p. 1703-1714.
72. Maneatis, J. G., Low-jitter process-independent DLL and PLL based on self-biased techniques. IEEE Journal of Solid-State Circuits, 1996. 31(11): p. 1723-1732.
73. IEEE, IEEE Standard for Safety Levels with Respect to Human Exposure to Radio Frequency Electromagnetic Fields, 3 kHz to 300 GHz. 2006, IEEE.
74. Wellens, J., O. Deschaume, T. Putzeys, S. Eyley, W. Thielemans, N. Verhaert, and C. Bartic, Sulfobetaine-based ultrathin coatings as effective antifouling layers for implantable neuroprosthetic devices. Biosens Bioelectron, 2023. 226: p. 115121.
75. Chou, Y. N., T. C. Wen, and Y. Chang, Zwitterionic surface grafting of epoxylated sulfobetaine copolymers for the development of stealth biomaterial interfaces. Acta Biomater, 2016. 40: p. 78-91.
76. Bon, C. Y., S. Mugobera, I. Phiri, K. S. Lee, J. H. Park, J. M. Ko, K. Lee, H. Kwon, J. Park, and S.-I. Yoo, Zwitterionic silica sulfobetaine grafted activated carbon as electrode material for supercapacitors. Colloids Surf A: Physicochem Eng Asp, 2024. 694: p. 134161.
77. Maor, E., A. Ivorra, and B. Rubinsky, Non thermal irreversible electroporation: novel technology for vascular smooth muscle cells ablation. PLoS One, 2009. 4(3): p. e4757.
78. Cemazar, M., C. S. Parkins, A. L. Holder, D. J. Chaplin, G. M. Tozer, and G. Sersa, Electroporation of human microvascular endothelial cells: evidence for an anti-vascular mechanism of electrochemotherapy. Br J Cancer, 2001. 84(4): p. 565-70.
79. Maor, E., A. Ivorra, J. Leor, and B. Rubinsky, The Effect of Irreversible Electroporation on Blood Vessels. Technology in Cancer Research & Treatment, 2007. 6(4): p. 307-312.
80. Maor, E., A. Ivorra, J. J. Mitchell, and B. Rubinsky, Vascular smooth muscle cells ablation with endovascular nonthermal irreversible electroporation. J Vasc Interv Radiol, 2010. 21(11): p. 1708-15.

1. A CMOS nanozyme device comprising:
a working electrode;
a counter electrode spaced from the working electrode;
a pH sensor configured to provide an indication of pH around the device;
the pH sensor including an ion-sensitive field effect transistor; and
a power source operable to provide electricity to the working electrode, counter electrode and pH sensor to sense or to actuate one or more chemical reactions, optionally wherein the CMOS nanozyme device has a volume of about 1 fL or less.

2. The CMOS nanozyme device of claim 1, wherein the working electrode and the counter electrode operate to oxidize or reduce analytes at the working electrode.

3. The CMOS nanozyme device of claim 2, wherein the working electrode is functionalized by one or more aptamers or peptides or antibodies or antibody fragments.

4. The CMOS nanozyme device of claim 1, wherein pH modulation is provided based on a water splitting reaction at the working electrode and the counter electrode to provide hydrogen and oxygen ions.

5. The CMOS nanozyme device of claim 4, further comprising a passivation layer, wherein the passivation layer provides an ion sensitive layer of an ion-sensitive field effect transistor that associates and dissociates protons as a function of pH to modulate a gate voltage of the field effect transistor with respect to a reference field effect transistor.

6. The CMOS nanozyme device of claim 5, wherein the gate voltage may be used to control pH modulation.

7. The CMOS nanozyme device of claim 1, wherein the power source is optical-based.

8. The CMOS nanozyme device of claim 7, further comprising a photodiode.

9. The CMOS nanozyme device of claim 7, wherein the device receives information via amplitude-shift-keying of an optical signal.

10. The CMOS nanozyme device of claim 9, wherein the received information may include control information to control activation of the working electrode, counter electrode and pH sensor.

11. The CMOS nanozyme device of claim 10, further comprising a controller programmable using the control information to control activation of the working electrode, counter electrode and pH sensor.

12. The CMOS nanozyme device of claim 11, further comprising an electro-optic fluorescence modulator provided on a surface of the device to transmit information to a fluorescence microscope.

13. The CMOS nanozyme device of claim 1, wherein the power source is electrochemical.

14. The CMOS nanozyme device of claim 13, further comprising a layer of polydimethylsiloxane provided on at least one side of the device to provide an oxygen-permeable membrane.

15. The CMOS nanozyme device of claim 13, wherein the power source is a glucose fuel cell comprising:
a porous platinum anode formed on a bottom surface of the device;
a CeO₂ electrolyte provided above the porous platinum anode; and
a dense platinum cathode provided above the CeO₂ electrolyte,
wherein the dense platinum cathode is provided in contact with the bottom surface of the device;
wherein glucose reacts with water at the anode to provide gluconic acid and protons and electrons that pass through the electrolyte to the cathode such that the moving electrons provide electricity.

16. The CMOS nanozyme device of claim 1, wherein the device is controlled using a closed-loop response based on actuation of molecular reactions and sensed information.

17. The CMOS nanozyme device of claim 16, wherein the working electrode and the counter electrode provide a two-electrode potentiostat used to sense molecular reactions.

18. An implantable active bioelectronics device, comprising:
a configuration which has a scale of about 1 pL volume or less that acts to sense and actuate one or more molecular reactions.

19. A CMOS nanozyme device comprising:
a working electrode;
a counter electrode spaced from the working electrode;
an ion-sensitive field effect transistor; and
a power source operable to provide electricity to the working electrode, counter electrode and ion-sensitive field effect transistor, or
a CMOS nanozyme device comprising:
a working electrode;
a counter electrode spaced from the working electrode;
an ion-sensitive field effect transistor as a sensor for pH, NH₃, CO₂, O₂, NO, or urea around the device; and
a power source operable to provide electricity to the working electrode, counter electrode and ion-sensitive field effect transistor to sense pH, NH₃, CO₂, O₂, NO, or urea or one or more chemical reactions, or
a CMOS nanozyme device comprising:
a working electrode;
a counter electrode spaced from the working electrode;
a temperature sensor to sense temperature around the device; and
a power source operable to provide electricity to the working electrode, counter electrode and temperature sensor, or
an actuating CMOS nanozyme device comprising:
a potentiostat comprising a working electrode and a pseudo-reference electrode which effects oxidation or reduction of a predefined analyte at the working electrode.

20. A method for effecting a molecular reaction in a cell or in an extracellular space comprising providing a CMOS nanozyme device described herein inside the cell or extracellular space under conditions effecting powering of the CMOS nanozyme or device and thereby effecting the molecular reaction in the cell or in the extracellular space.
